(19) United States
(12) Patent Application Publication
(10) Pub. No.: US 2025/0111799 A1
(43) Pub. Date: Apr. 3, 2025

(54) SYSTEMS, METHODS, AND MEDIA FOR SIMULATING INTERACTIONS WITH AN INFANT

(71) Applicants: Case Western Reserve University, Cleveland, OH (US); MaineHealth, Portland, ME (US)

(72) Inventors: Mark Griswold, Cleveland, OH (US); Henry Eastman, Cleveland, OH (US); Anastasiya Kurylyuk, Cleveland, OH (US); James Gasparatos, Cleveland, OH (US); Erin Henninger, Cleveland, OH (US); Mary C. Ottolini, Portland, ME (US); Michael A. Ferguson, Cape Elizabeth, ME (US); Misty Melendi, Falmouth, ME (US); Allison Zanno, Falmouth, ME (US)

(21) Appl. No.: 18/728,689

(22) PCT Filed: Jan. 17, 2023
(86) PCT No.: PCT/US2023/060784

§ 371 Date: Jul. 12, 2024

Related U.S. Application Data
(60) Provisional application No. 63/299,888, filed on Jan. 14, 2022.
(60) Provisional application No. 63/300,024, filed on Jan. 16, 2022.

(51) Int. Cl. G09B 9/00; G02B 27/01; G06F 3/04842; G06T 19/00

(52) U.S. Cl. CPC G09B 9/00; G02B 27/017; G06F 3/04842; G06T 19/006

(57) ABSTRACT

Systems, methods, and media for simulating interactions with an infant are provided. In some embodiments, a system comprises: a display; and at least one processor, wherein the at least one processor is programmed to: receive input to add a state; receive input setting one or more parameters associated with the state; cause content to be presented based on the parameters via the display; save the parameters; cause a simulation to be created; receive a selection of the state; and cause a simulated infant in the simulation to be presented based on the one or more parameters.

### CROSS-REFERENCE TO RELATED APPLICATIONS

This application is based on, claims the benefit of, and claims priority to, U.S. Provisional Patent Application No. 63/299,888, filed Jan. 14, 2022, and is based on, claims the benefit of, and claims priority to, U.S. Provisional Patent Application No. 63/300,024, filed Jan. 16, 2022. Each of the preceding applications is hereby incorporated by reference herein in its entirety for all purposes.

### STATEMENT REGARDING FEDERALLY SPONSORED RESEARCH

N/A

### BACKGROUND

Complications can occur during labor and/or immediately after birth that can impact the health of an infant. While these complications can be described in a textbook, the opportunity to train healthcare personnel to effectively treat such complications is limited due to the unpredictability of such complications occurring.

Accordingly, new systems, methods, and media for simulating interactions with an infant are desirable.

### SUMMARY

In accordance with some embodiments of the disclosed subject matter, systems, methods, and media for simulating interactions with an infant are provided.

In accordance with some embodiments of the disclosed subject matter, a system for simulating interactions with an infant is provided, the system comprising: a display; and at least one processor, wherein the at least one processor is programmed to: receive input to add a state; receive input setting one or more parameters associated with the state; cause content to be presented based on the parameters via the display; save the parameters; receive a selection of the state; and in response to receiving the selection of the state, cause a simulated infant in the simulation to be presented based on the one or more parameters.

In some embodiments, the at least one processor is further programmed to: receive, during the simulation, an indication that user input has been received; select a second state based on the user input; and cause the simulated infant to be updated based on the second state.

In some embodiments, the at least one processor is further programmed to: transmit parameters associated with the second state to the remote computing device.

In some embodiments, the at least one processor is further programmed to: receive, during the simulation from a remote computing device, an image of the simulated infant being presented by the remote computing device; and present the image of the simulated infant via the display.

In some embodiments, the at least one processor is further programmed to: receive, via a user interface, a selection of a user interface element; and store an annotation to the simulation to be saved in connection with the simulation.

In accordance with some embodiments of the disclosed subject matter, a system for simulating interactions with an infant is provided, the system comprising: a head mounted display comprising: a display; and at least one processor, wherein the at least one processor is programmed to: join a simulation of an infant; receive content from a server; cause the content to be presented anchored at a location corresponding to a physical representation of an infant; receive, from a remote device, one or more parameters associated with the simulated infant; and cause presentation of the content to be updated based on the one or more parameters.

In some embodiments, the at least one processor is further programmed to: receive, from the remote device, one or more updated parameters associated with the simulated infant; and cause presentation of the content to be updated based on the one or more updated parameters.

In some embodiments, the at least one processor is further programmed to: determine that user input has been received; transmit, to the remote device, an indication that the user input has been received; and receive, subsequent to transmitting the indication, the one or more updated parameters associated with the simulated infant.

In some embodiments, the at least one processor is further programmed to: detect a position of an object in proximity to the physical representation of the infant; and in response to detecting the position of the object in proximity to the physical representation of the infant, cause a virtual representation of a medical device to be presented in connection with the content.

In some embodiments, the object is a finger of the user, and wherein the medical device is a stethoscope.

In some embodiments, the at least one processor is further programmed to: transmit, to the remote computing device, a position of the object in proximity to the physical representation of the infant.

In some embodiments, the at least one processor is further programmed to: detect a position of an object in proximity to the physical representation of the infant; and cause presentation of the content to be updated based on the position of the object.

In some embodiments, the at least one processor is further programmed to: cause, in response to detecting the position of the object, a heart rate of the simulated infant to be presented.

In some embodiments, the heart rate is presented using a user interface element.

In some embodiments, the heart rate is presented using an audio signal.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a head mounted display that can be used in accordance with some embodiments of the disclosed subject matter.

FIG. 2 shows an example of a system including a head mounted display and a server in accordance with some embodiments of the disclosed subject matter.

FIG. 3 shows an example of hardware that can be used to implement at least one head mounted display, at least one server, and at least one user input device in accordance with some embodiments of the disclosed subject matter.

FIG. 4A shows an example of a system for interacting with a simulated infant, including a user and a physical representation of an infant prior to a simulation configured to simulate an infant has started in accordance with some embodiments of the disclosed subject matter.

FIG. 4B shows an example of the system for interacting with a simulated infant, including a user and a hologram overlaid on the physical representation of the infant after the simulation has started in accordance with some embodiments of the disclosed subject matter.

FIG. 5 shows an example of another system for interacting with a simulated infant and another user in accordance with some embodiments of the disclosed subject matter.

FIG. 6 shows an example of a user interface that can be used to generate a simulation scenario for generating a simulation of an infant in accordance with some embodiments of the disclosed subject matter.

FIG. 7 shows portions of portions of a user interface that can be used to generate a simulation scenario for generating a simulation of an infant in accordance with some embodiments of the disclosed subject matter.

FIG. 8 shows an example of a user interface that can be used to present a simulation of an infant in accordance with some embodiments of the disclosed subject matter.

FIG. 9 shows an example of a user interface that can be used to review a simulation of an infant in accordance with some embodiments of the disclosed subject matter.

FIG. 10 shows an example of a flow for generating and presenting a simulation of an infant to multiple users in accordance with some embodiments of the disclosed subject matter.

FIG. 11 shows an example of a process for generating a simulation scenario for a simulation with an infant in accordance with some embodiments of the disclosed subject matter.

FIG. 12 shows an example of a process for presenting a simulation scenario for a simulation with an infant in accordance with some embodiments of the disclosed subject matter.

FIG. 13 shows an example of a process for participating in a simulation scenario for a simulation with an infant in accordance with some embodiments of the disclosed subject matter.

FIG. 14 shows an example of a simulation environment and a system including head mounted displays and a computing device and a server in accordance with some embodiments of the disclosed subject matter.

FIG. 15 shows an example of a simulation presented by a hear mounted display in a system including head mounted displays and a computing device and a server in accordance with some embodiments of the disclosed subject matter.

### DETAILED DESCRIPTION

Before any embodiments of the disclosed subject matter are explained in detail, it is to be understood that the disclosed subject matter is not limited in its application to the details of construction and the arrangement of components set forth in the following description or illustrated in the following drawings. The disclosed subject matter is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the disclosed subject matter. Various modifications to the illustrated embodiments will be readily apparent to those skilled in the art, and the generic principles herein can be applied to other embodiments and applications without departing from embodiments of the disclosed subject matter. Thus, embodiments of the disclosed subject matter are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the disclosed subject matter. Skilled artisans will recognize the examples provided herein have many useful alternatives and fall within the scope of embodiments of the disclosed subject matter.

In accordance with some embodiments of the disclosed subject matter, mechanisms (which can include systems, methods and/or media) for simulating interactions with an infant are provided.

In some embodiments, mechanisms described herein can be used to implement a software suite for headsets (e.g., hear mounted displays), mobile devices, and desktop computers that facilitates creation and sharing of simulation scenarios related to complications that can happen immediately after birth. In some embodiments, the software suite can facilitate overlay of a holographic infant onto an infant mannikin to provide a flexible and more realistic (e.g., compared to use of the mannikin alone) simulation tool paired with tactile practice. In some embodiments, mechanisms described herein can be implemented on two platforms and with three different modes. For example, mechanisms described herein can be used to implement a screen-based application (e.g., which can be more suitable for use with a personal computer, laptop computer, tablet computer, etc.) which can be used to edit, present, publish, and/or review a simulation. As another example, mechanisms described herein can be used to implement a mobile application (e.g., which can be more suitable for use with an HMD, a smartphone, a tablet computer, etc.) which can be used to participate in a simulation with a hologram of a simulated infant overlaid over a mannikin. In some embodiments, mechanisms described herein can be used to facilitate instruction of medical personnel for relatively uncommon medical events, such as resuscitation of an infant. For example, this can reduce the necessity of instructional personnel to travel to a location of the personnel to be trained. In such an example, one or more HMDs and a physical representation (e.g., a mannequin) can be shipped to the personnel to be trained, while an instructor can stay at a remote location (e.g., their office).

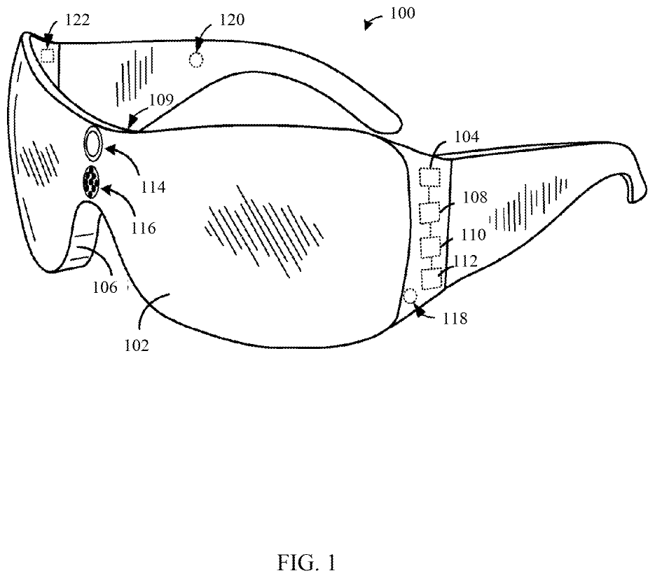

FIG. 1 shows an example 100 of a head mounted display (HMD) that can be used in accordance with some embodiments of the disclosed subject matter. As shown in FIG. 1, head mounted display 100 can include a display processor 104 and a transparent display 102 that can be used to present images, such as holographic objects, to the eyes of a wearer of HMD 100. In some embodiments, transparent display 102 can be configured to visually augment an appearance of a physical environment to a wearer viewing the physical environment through transparent display 102. For example, in some embodiments, the appearance of the physical environment can be augmented by graphical content (e.g., one or more pixels each having a respective color and brightness) that is presented via transparent display 102 to create a mixed reality (or augmented reality environment). Note that as used herein, mixed reality and augmented reality are meant to convey similar experiences, but a mixed reality environment is intended to convey a more immersive environment than an augmented reality environment. Additionally or alternatively, in some embodiments, transparent display 102 can be configured to render a fully opaque virtual environment (e.g., by using one or more techniques to block the physical environment from being visible through HMD 100). In some embodiments, a non-transparent display can be used in lieu of transparent display 102. In some such embodiments, one or more cameras can be used to generate a real-time representation of at least a portion of the physical environment in which HMD 100 is located. For example, an HMD with a non-transparent display can simulate a mixed reality environment using images of a physical environment and graphics (e.g., 3D models) displayed with the images of the physical environment as though the graphics are physically present within the physical environment. In some such embodiments, HMD 100 can be used to present a virtual reality environment. In some such embodiments, the virtual reality environment can include a fully virtual environment. Alternatively, in some such embodiments, the virtual reality environment can be used to present an augmented reality presentation via pass-through virtual reality techniques. For example, one or more cameras (e.g., one or more cameras of HMD 100) can be used to capture image data representing a physical environment around a user of HMD 100, and can present image data representing the physical environment around the user of HMD 100 using a non-transparent display of HMD 100 (e.g., with virtual objects overlaid with the image data to present an augmented reality presentation). Note that the term extended reality is sometimes used herein to refer to technologies that facilitate an immersive experience, including augmented reality, mixed reality, and virtual reality.

As shown in FIG. 1, in some embodiments, transparent display 102 can include one or more image producing elements (e.g., display pixels) located within lenses 106 (such as, for example, pixels of a see-through Organic Light-Emitting Diode (OLED) display). Additionally or alternatively, in some embodiments, transparent display 102 can include a light modulator on an edge of the lenses 106.

In some embodiments, HMD 100 can include various sensors and/or other related systems. For example, HMD 100 can include a gaze tracking system 108 that can include one or more image sensors that can generate gaze tracking data that represents a gaze direction of a wearer's eyes. In some embodiments, gaze tracking system 108 can include any suitable number and arrangement of light sources and/or image sensors. For example, as shown in FIG. 1, the gaze tracking system 108 of HMD 100 can utilize at least one inward facing sensor 109. In some embodiments, a user can be prompted to permit the acquisition and use of gaze information to track a position and/or movement of the user's eyes.

In some embodiments, HMD 100 can include a head tracking system 110 that can utilize one or more motion sensors, such as motion sensors 112 shown in FIG. 1, to capture head pose data that can be used to track a head position of the wearer, for example, by determining the direction and/or orientation of a wearer's head. In some embodiments, head tracking system 110 can include an inertial measurement unit configured as a three-axis or three-degree of freedom position sensor system.

In some embodiments, head tracking system 110 can also support other suitable positioning techniques, such as Global Positioning System (GPS) or other global navigation systems, indoor position tracking systems (e.g., using Bluetooth low energy beacons), etc. Further, while specific examples of position sensor systems have been described, it will be appreciated that any other suitable position sensor systems can be used. For example, head pose and/or movement data can be determined based on sensor information from any suitable combination of sensors mounted on the wearer and/or external to the wearer including but not limited to any number of gyroscopes, accelerometers, inertial measurement units (IMUs), GPS devices, barometers, magnetometers, cameras (e.g., visible light cameras, infrared light cameras, time-of-flight depth cameras, structured light depth cameras, etc.), communication devices (e.g., Wi-Fi antennas/interfaces, Bluetooth, etc.), etc.

In some embodiments, HMD 100 can include an optical sensor system that can utilize one or more outward facing sensors, such as optical sensor 114, to capture image data of the environment. In some embodiments, the captured image data can be used to detect movements captured in the image data, such as gesture-based inputs and/or any other suitable movements by a user waring HMD 100, by another person in the field of view of optical sensor 114, or by a physical object within the field of view of optical sensor 114. Additionally, in some embodiments, the one or more outward facing sensor(s) can capture 2D image information and/or depth information from the physical environment and/or physical objects within the environment. For example, the outward facing sensor(s) can include a depth camera, a visible light camera, an infrared light camera, a position tracking camera, and/or any other suitable image sensor or combination of image sensors.

In some embodiments, a structured light depth camera can be configured to project a structured infrared illumination, and to generate image data of illumination reflected from a scene onto which the illumination is projected. In such embodiments, a depth map of the scene can be constructed based on spacing between features in the various regions of an imaged scene. Additionally or alternatively, in some embodiments, a continuous wave time-of-flight depth camera, a pulsed time-of-flight depth camera or other sensor (e.g., LiDAR), a structured light camera, etc. In some embodiments, illumination can be provided by an infrared light source 116, and/or a visible light source.

In some embodiments, HMD 100 can include a microphone system that can include one or more microphones, such as microphone 118, that can capture audio data. In some embodiments, audio can be presented to the wearer via one or more speakers, such as speaker 120.

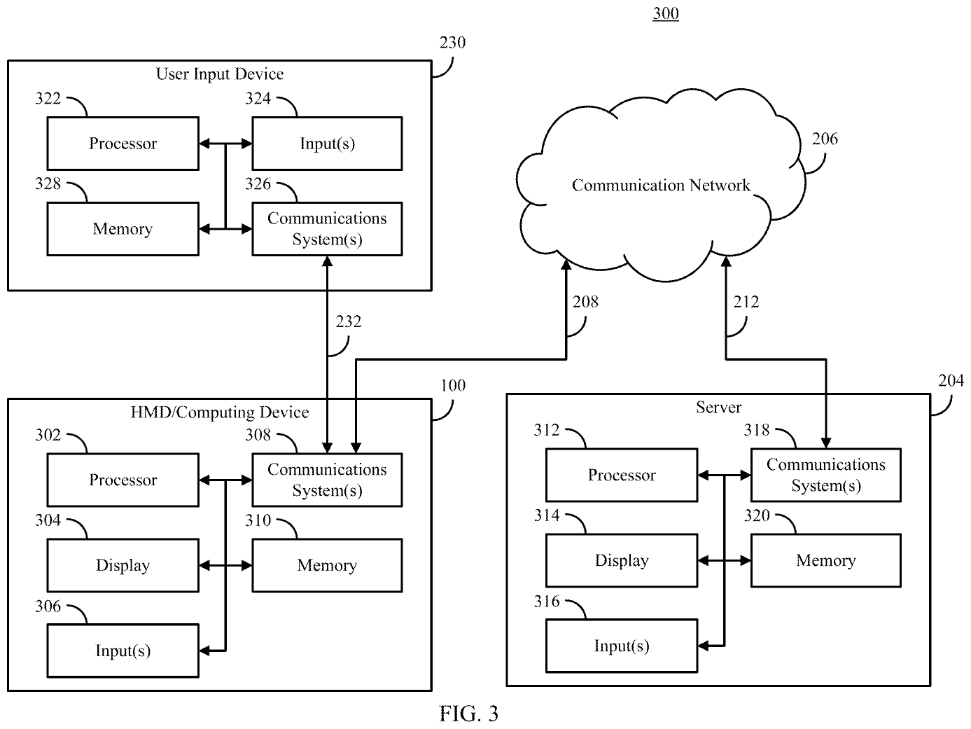

In some embodiments, HMD 100 can include a controller, such as controller 122, which can include, for example, a processor and/or memory (as described below in connection with FIG. 3) that are in communication with the various sensors and systems of HMD 100. In some embodiments, controller 122 can store, in memory, instructions that are executable by the processor to receive signal inputs from the sensors, determine a pose of HMD 100, and adjust display properties for content displayed using transparent display 102.

In some embodiments, HMD 100 can have any other suitable features or combination of features, such as features described in U.S. Pat. No. 9,495,801 issued to Microsoft Technology Licensing, LLC, which is hereby incorporated by reference herein in its entirety. The description herein of HMD 100 is merely for illustration of hardware that can be used in connection with the disclosed subject matter. However, the disclosed subject matter can be used with any suitable mixed reality device and/or augmented reality device, such as the HoloLens® and HoloLens 2® made by Microsoft®, and/or devices described in U.S. Pat. Nos. 8,847,988, 8,941,559, U.S. Patent Application Publication No. 2014/0160001, each of which is hereby incorporated by reference herein in its entirety.

In some embodiments, the disclosed subject matter can be used with mobile computing devices (e.g., smartphones, tablet computers, etc.) and/or non-mobile computing devices (e.g., personal computers, laptop computers, server computers, etc.). For example, a smartphone can be used to provide an mixed reality and/or augmented reality experience.

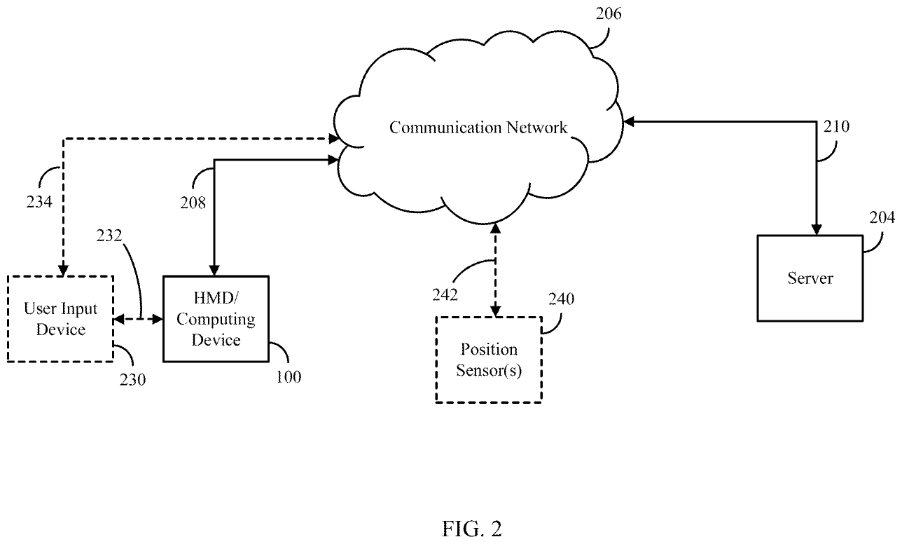

FIG. 2 shows an example 200 of a system including a head mounted display and/or computing device 100 and a server in accordance with some embodiments of the disclosed subject matter. As shown in FIG. 2, system 200 can include one or more HMDs 100. Alternatively, in some embodiments, system 200 can include one or more computing devices (e.g., smartphones, tablet computers, personal computers, laptop computers, etc.). In some embodiments, system 200 can include a server 204 that can provide content and/or control presentation of content that is to be presented by HMD 100. In some embodiments, server 204 can be implemented using any suitable computing device such as a server computer, an HMD, a tablet computer, a smartphone, a personal computer, a laptop computer, etc. Note that although mechanisms described herein are generally described in connection with an HMD, any suitable computing device can be used to present a simulated infant and can perform actions described below in connection with an HMD 100.

In some embodiments, HMD 100 can connect to communication network 206 via a communications link 208, and server 204 can connect to communication network 206 via a communications link 210. Communication network 206 can be any suitable communication network or combination of communication networks. For example, communication network 206 can be a Wi-Fi network (which can include one or more wireless routers, one or more switches, etc.), a peer-to-peer network (e.g., a Bluetooth network, a Zigbee mesh network, etc.), a cellular network (e.g., a 3G network, a 4G network, a 5G network, etc., complying with any suitable standard, such as CDMA, GSM, LTE, LTE Advanced, NR, etc.), a wired network, etc. Communications links 208 and 210 can each be any suitable communications link or combination of communications links, such as a Wi-Fi links, Bluetooth links, cellular links, etc.

In some embodiments, server 204 can be located locally or remotely from HMD 100. Additionally, in some embodiments, multiple servers 204 can be used (which may be located in different physical locations) to provide different content, provide redundant functions, etc. In some embodiments, an HMD 100 in system 200 can perform one or more of the operations of server 204 described herein, such as instructing other HMDs about which content to present, for distributing updated information, etc. For example, a network of local HMDs (not shown) can be interconnected to form a mesh network, and an HMD acting as server 204 (e.g., HMD 100) can control operation of the other HMDs by providing updated information. Additionally, in some embodiments, the HMD acting as server 204 can be a node in the mesh network, and can communicate over another network (e.g., a LAN, cellular, etc.) to receive other information, such as information related to a remote user. In some such embodiments, the HMD acting as server 204 can determine which HMD or HMDs to distribute information to that indicates that an avatar of a remote user is to be presented in connection with a hologram, placement information of the avatar, etc.

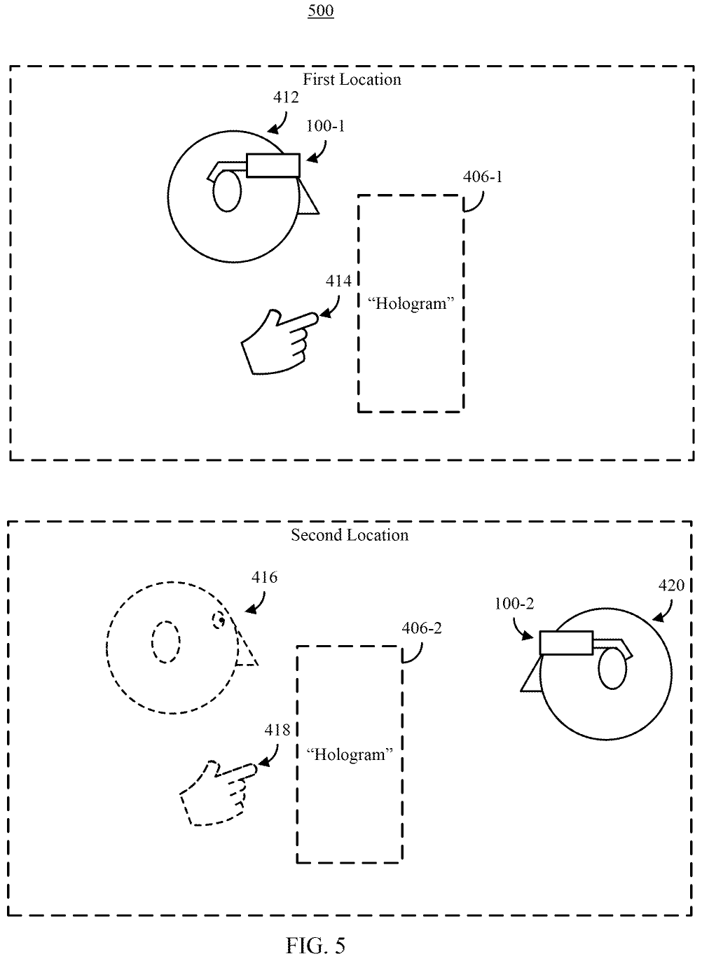

In some embodiments, one or more HMDs 100 that are participating in a simulation can be local to each other (e.g., in the same room). Additionally or alternatively, in a group of HMDs participating in a simulation, one or more of the HMDs can be remote from each other. For example, system 200 can be used to collaborate and/or interact with one or more wearers of HMDs 100 located in one or more remote locations (e.g., with a physical simulation of a subject at each location, which can be used to anchor a virtual simulation of the subject). In some embodiments, two HMDs 100 (and/or other computing devices, such as a computing device used to control the simulation state can be remote from each other if there is not a line of sight between them. For example, two computing devices can be considered remote from each other if they are located in different rooms, regardless of whether they are both connected to the same local area network (LAN) or to different networks. As another example, two computing devices that are connected to different LANs can be considered remote from each other. As yet another example, two computing devices that are connected to different subnets can be considered remote from each other. In some embodiments, for example as described below in connection with FIG. 5, two computing devices that are remote from each other can be used to collaborate by representing a remote user with an avatar in connection with a hologram being presented by at least one of the two HMDs 100.

In some embodiments, a user input device 230 can communicate with HMD 100 via a communications link 232. In some embodiments, communications link 232 can be any suitable communications link that can facilitate communication between user input device 230 and HMD 100. For example, communications link 232 can be a wired link (e.g., a USB link, an Ethernet link, a proprietary wired communication link, etc.) and/or a wireless link (e.g., a Bluetooth link, a Wi-Fi link, etc.). In some embodiments, user input device 230 can include any suitable sensors for determining a position of user input device 230 with respect to one or more other devices and/or objects (e.g., HMD 100, a particular body part of a wearer of HMD 100, etc.), and/or a relative change in position (e.g., based on sensor outputs indicating that user input device 230 has been accelerated in a particular direction, that user input device 230 has been rotated in a certain direction, etc.). For example, in some embodiments, user input device 230 can include one or more accelerometers, one or more gyroscopes, one or more electronic compasses, one or more image sensors, an inertial measurement unit, etc. In some embodiment, in addition to or in lieu of communication link 232, user input device 230 can communicate with HMD 100, server 204, and/or any other suitable device(s) via a communication link 234. In some embodiments, communication link 234 can be any suitable communications link or combination of communications links, such as a Wi-Fi link, a Bluetooth link, a cellular link, etc.

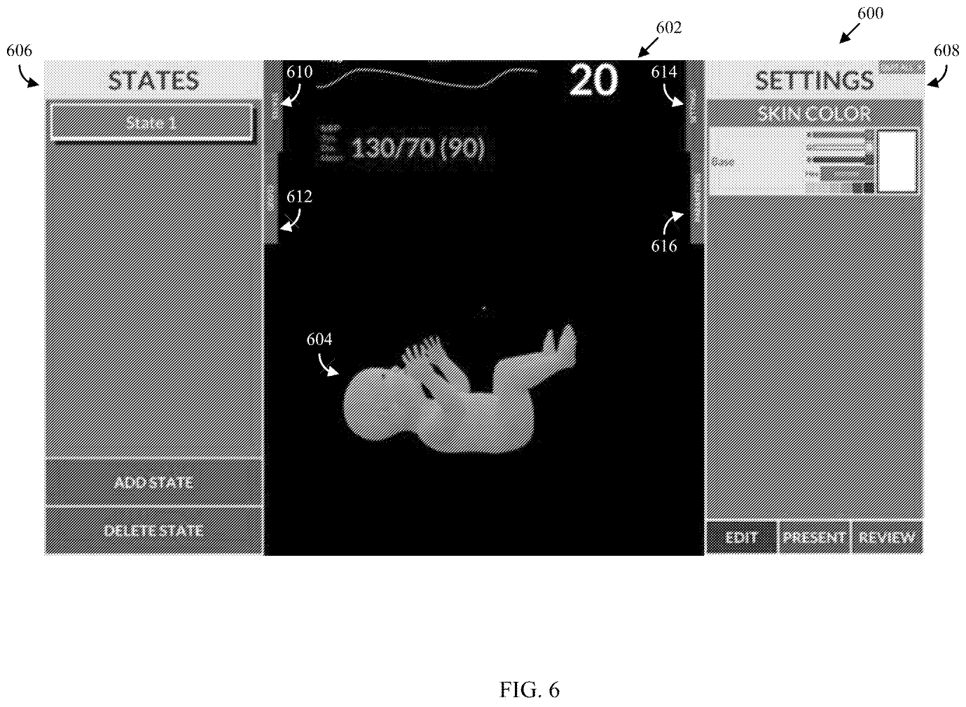

In some embodiments, user input device 230 can be used to manipulate the position and/or orientation of one or more tools or objects used in a process for simulating an infant (e.g., as described below in connection with FIGS. 6-10).

In some embodiments, HMD 100 and/or server 204 can receive data from user input device 230 indicating movement and/or position data of user input device 230. Based on the data from user input device 230, HMD 100 and/or server 204 can determine a location and/or direction of a user interface element (e.g., an objects used in a process for simulating an infant) to be presented as part of holograms presented by HMD 100 and/or one or more other HMDs presenting the same content as HMD 100.

In some embodiments, user input device 230 can be an integral part of HMD 100, which can determine a direction in which HMD 100 is pointing with respect to content and/or which can receive input (e.g., via one or more hardware- and/or software-based user interface elements such as buttons, trackpads, etc.).

In some embodiments, one or more position sensors 240 can communicate with HMD 100, one or more other computing devices, and/or server 204 via a communications link 242. In some embodiments, communications link 242 can be any suitable communications link that can facilitate communication between position sensor(s) 240 and one or more other devices. For example, communications link 242 can be a wired link (e.g., a USB link, an Ethernet link, a proprietary wired communication link, etc.) and/or a wireless link (e.g., a Bluetooth link, a Wi-Fi link, etc.). In some embodiments, position sensor(s) 240 can include any suitable sensors for determining a position of a user of one or more HMDs 100 in the same physical space as position sensor 240, a position of one or more of the user's body parts (e.g., hands, fingers, etc.), one or more objects (e.g., a physical representation of an infant, a medical device, a prop medical device, etc.), etc.

In some embodiments, position sensor(s) 240 can be implemented using any suitable position sensor or combination of positions sensors. For example, position sensor 240 can include a 3D camera (e.g., based on time-of-flight, continuous wave time-of-flight, structured light, stereoscopic depth sensing, and/or any other suitable technology), a 2D camera and a machine learning model trained to estimate the position of one or more objects (e.g., hands, arms, heads, torsos, etc.) in the image, a depth sensor (e.g., LiDAR-based, sonar-based, radar-based, etc.), any other suitable sensor that can be configured to determine to the position of one or more objects, or any other suitable combination thereof.

In some embodiment, in addition to or in lieu of communication link 232, user input device 230 can communicate with HMD 100, server 204, and/or any other suitable device(s) via a communication link 234. In some embodiments, communication link 234 can be any suitable communications link or combination of communications links, such as a Wi-Fi link, a Bluetooth link, a cellular link, etc.

FIG. 3 shows an example 300 of hardware that can be used to implement at least one of HMD 100, server 204 and user input device 230 in accordance with some embodiments of the disclosed subject matter. As shown in FIG. 3, in some embodiments, HMD 100 can include a processor 302, a display 304, one or more inputs 306, one or more communication systems 308, and/or memory 310. In some embodiments, processor 302 can be any suitable hardware processor or combination of processors, such as a central processing unit (CPU), a graphics processing unit (GPU), a field programmable gate array (FPGA), an application specific integrated circuit (ASIC), etc. In some embodiments, display 304 can include any suitable display device(s), such as a transparent display as described above in connection with FIG. 1, a touchscreen, etc. In some embodiments, inputs 306 can include any suitable input device(s) and/or sensor(s) that can be used to receive user input, such as gaze tracking system 108, head tracking system 110, motion sensors 112, optical sensor 114, microphone 118, a touchscreen, etc.

In some embodiments, communications systems 308 can include any suitable hardware, firmware, and/or software for communicating information over communication network 206 and/or any other suitable communication networks. For example, communications systems 308 can include one or more transceivers, one or more communication chips and/or chip sets, etc. In a more particular example, communications systems 308 can include hardware, firmware and/or software that can be used to establish a Wi-Fi connection, a Bluetooth connection, a cellular connection, etc.

In some embodiments, memory 310 can include any suitable storage device or devices that can be used to store instructions, values, etc., that can be used, for example, by processor 302 to present content using display 304, to communicate with server 204 via communications system(s) 308, etc. Memory 310 can include any suitable volatile memory, non-volatile memory, storage, any other suitable type of storage medium, or any suitable combination thereof. For example, memory 310 can include RAM, ROM, EEPROM, one or more flash drives, one or more hard disks, one or more solid state drives, one or more optical drives, etc. In some embodiments, memory 310 can have encoded thereon a computer program for controlling operation of HMD 100. In some such embodiments, processor 302 can execute at least a portion of the computer program to present content (e.g., one or more holograms of an infant), receive content from server 204, transmit information to server 204, etc. In some embodiments, HMD 100 can use any suitable hardware and/or software for rendering the content received from server 204, such as Unity 3D available from Unity Technologies. Additionally, in some embodiments, any suitable communications protocols can be used to communicate control data, image data, audio, etc., between HMD 100 and server 204, such as networking software available from Unity Technologies.

In some embodiments, server 204 can include a processor 312, a display 314, one or more inputs 316, one or more communication systems 318, and/or memory 320. In some embodiments, processor 312 can be any suitable hardware processor or combination of processors, such as a CPU, a GPU, an FPGA, an ASIC, etc. In some embodiments, display 314 can include any suitable display devices, such as a computer monitor, a touchscreen, a television, etc. In some embodiments, inputs 316 can include any suitable input devices and/or sensors that can be used to receive user input, such as a keyboard, a mouse, a touchscreen, a microphone, etc.

In some embodiments, communications systems 318 can include any suitable hardware, firmware, and/or software for communicating information over communication network 206 and/or any other suitable communication networks. For example, communications systems 318 can include one or more transceivers, one or more communication chips and/or chip sets, etc. In a more particular example, communications systems 318 can include hardware, firmware and/or software that can be used to establish a Wi-Fi connection, a Bluetooth connection, a cellular connection, etc.

In some embodiments, memory 320 can include any suitable storage device or devices that can be used to store instructions, values, etc., that can be used, for example, by processor 312 to present content using display 314, to communication with one or more HMDs 100, etc. Memory 320 can include any suitable volatile memory, non-volatile memory, storage, any other suitable type of storage medium, or any suitable combination thereof. For example, memory 320 can include RAM, ROM, EEPROM, one or more flash drives, one or more hard disks, one or more solid state drives, one or more optical drives, etc. In some embodiments, memory 320 can have encoded thereon a server program for controlling operation of server 204. In such embodiments, processor 312 can execute at least a portion of the server program to transmit content (e.g., one or more holograms) to one or more HMDs 100, receive content from one or more HMDs 100, provide instructions to one or more devices (e.g., HMD 100, user input device 230, another server, a personal computer, a laptop computer, a tablet computer, a smartphone, etc.), receive instructions from one or more devices (e.g., HMD 100, user input device 230, another server, a personal computer, a laptop computer, a tablet computer, a smartphone, etc.), etc.

In some embodiments, user input device 230 can include a processor 322, one or more inputs 324, one or more communication systems 326, and/or memory 328. In some embodiments, processor 322 can be any suitable hardware processor or combination of processors, such as a CPU, a GPU, an FPGA, an ASIC, etc. In some embodiments, inputs 324 can include any suitable input devices and/or sensors that can be used to receive user input, such as one or more physical or software buttons, one or movement sensors, a microphone, a touchpad, etc.

In some embodiments, communications systems 326 can include any suitable hardware, firmware, and/or software for communicating information over communications link 232, communications link 234, and/or any other suitable communications links. For example, communications systems 326 can include one or more transceivers, one or more communication chips and/or chip sets, etc. In a more particular example, communications systems 326 can include hardware, firmware and/or software that can be used to establish a Wi-Fi connection, a Bluetooth connection, a cellular connection, etc.

In some embodiments, memory 328 can include any suitable storage device or devices that can be used to store instructions, values, etc., that can be used, for example, by processor 322 to determine when input (e.g., user input) is received, to record sensor data, to communicate sensor data with one or more HMDs 100, etc. Memory 328 can include any suitable volatile memory, non-volatile memory, storage, any other suitable type of storage medium, or any suitable combination thereof. For example, memory 328 can include RAM, ROM, EEPROM, one or more flash drives, one or more hard disks, one or more solid state drives, one or more optical drives, etc. In some embodiments, memory 328 can have encoded thereon a computer program for controlling operation of user input device 230. In such embodiments, processor 322 can execute at least a portion of the computer program to transmit data (e.g., representing sensor outputs) to one or more HMDs 100, to transmit data (e.g., representing sensor outputs) to one or more servers 204, etc.

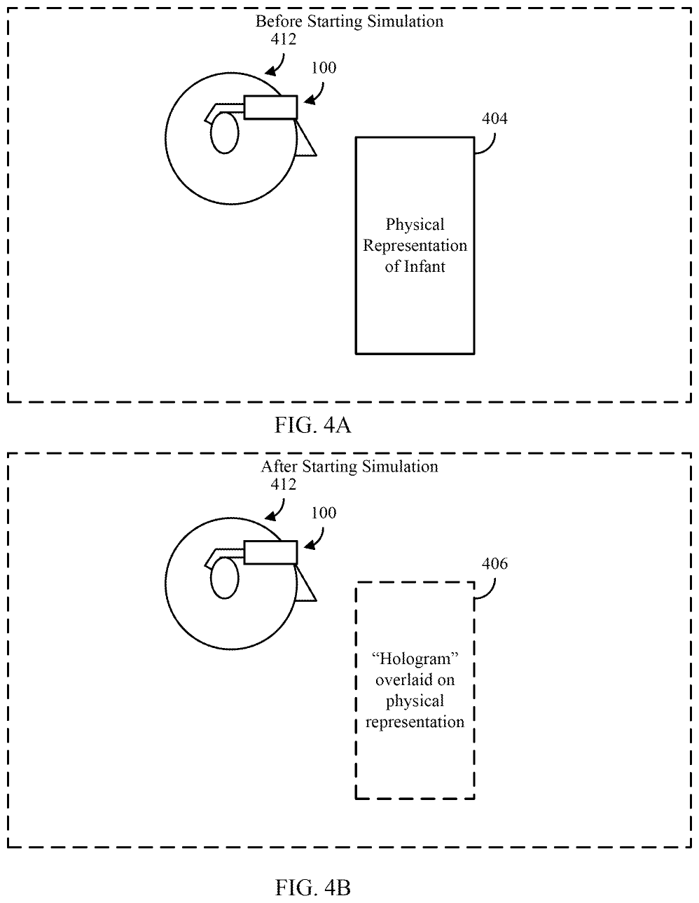

FIGS. 4A and 4B show an example of a system for interacting with a simulated infant, including a user and a physical representation of an infant prior to, and after, an simulation configured to simulate an infant has started in accordance with some embodiments of the disclosed subject matter.

As shown in FIG. 4A, an HMD 100 worn by a user 412 can be in the same environment as a physical representation of an infant (e.g., a mannikin, a robot, etc.) 404. In some embodiments, HMD 100 can start a simulation that is implemented in accordance with some embodiments of the disclosed subject matter. In some embodiments, HMD 100 can use any suitable technique or combination of techniques to start a simulation (e.g., after an application configured to present the application has been launched) For example, HMD 100 can capture an image of infant 404 using one or more image sensors (e.g., optical sensor 114) and/or a symbol (e.g., a QR code) associated with infant 404. As another example, HMD 100 can be used to select a link to join a simulation and/or can receive an invitation and/or other instruction to a simulation. As shown in FIG. 4B, after a simulation has started, HMD 100 can present content 406 (e.g., a hologram) that represents an infant as an overlay at a position of infant 404. For example, hologram 406 can be anchored at a physical location associated with infant 404.

FIG. 5 shows an example 500 of another system for interacting with a simulated infant and another user in accordance with some embodiments of the disclosed subject matter. As shown in FIG. 5, a first HMD 100-1 worn by a first user 412 at a first location can present a hologram 406-1. In some embodiments, HMD 100-1 can track the position of a hand 414 of user 412 and/or one or more user input devices (not shown) with respect to hologram 406-1. In some embodiments, HMD 100-1 can use any suitable technique or combination of techniques to track the location and/or orientation of the user's hand and/or user input device. For example, HMD 100-1 can track the location of the user's hand visually using images produced by one or more image sensors (e.g., optical sensor 114) and/or any other suitable data, such as depth information in a scene. As another example, HMD 100-1 can track the location of the user's hand using one or more sensors to sense a position of a device held by (or otherwise attached) to the user's hand.

In some embodiments, HMD 100-1 can transmit information to server 204 indicating the position of HMD 100-1 and the user's hand with respect to hologram 406-1. As shown in FIG. 5, server 204 can transmit information to a second HMD 100-2 presenting a hologram 406-2 that includes the same content as hologram 406-1 (which may or may not be overlaid on a physical representation of an infant 404), where the information can indicate a position at which to present an avatar 416 representing user 412 of HMD 100-1 with respect to hologram 406-2. HMD 100-2 can use such information to present avatar 416 and a hand element 418 with hologram 406-2 to a second user 420. In some embodiments, HMD 100-1 can be caused to present an avatar of user 420 in connection with hologram 406-1 (not shown). Note that although users 312 and 320 are described as using HMDs 100, this is merely an example, and one or more users can participate in a shared mixed reality, augmented reality, and/or virtual reality experience using any suitable computing device.

FIG. 6 shows an example 600 of a user interface that can be used to generate a simulation scenario for generating a simulation of an infant in accordance with some embodiments of the disclosed subject matter. As shown in FIG. 6, user interface 600 can include a presentation portion 602 that can present a simulation 604 of an infant based on a currently selected state, and that presents physiological information (e.g., vitals) associated with a current state (e.g., heart rate, oxygen saturation, respiration rate, blood pressure, etc.). In some embodiments, user interface 600 can include a first user input portion 606 that can be used to add, delete, and/or reorder states to be included in a simulation, and a second user input portion 608 that can be used to adjust settings associated with the simulation. In some embodiments, first user input section 606 can include selectable user interface elements that can be used to add a new state, delete an existing state (e.g., a currently selected state), and/or to select and/or move an existing state. In some embodiments, second user input portion 608 can include selectable user interface elements to change a skin color of the simulated infant.

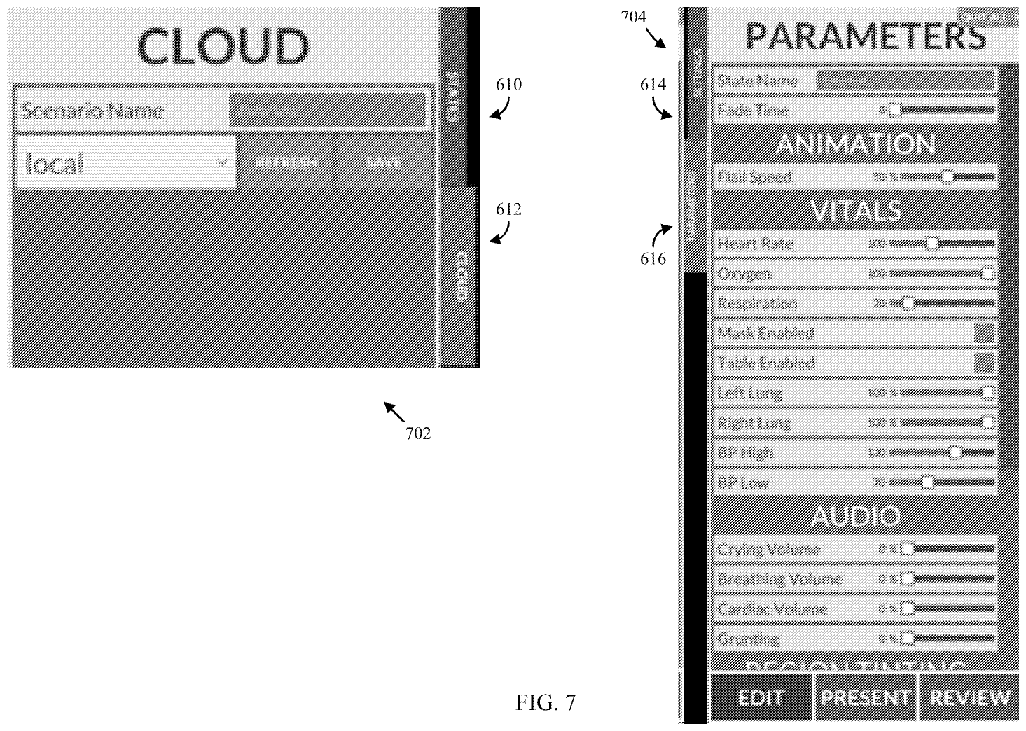

As described below in connection with FIG. 7, a selectable user interface element 610 can be selected to cause first user input section 606 to present user interface elements associated with states included in the simulation, and a selectable user interface element 612 can be selected to cause first user input section 606 to present user interface elements associated with saving and/or distributing the current simulation. A selectable user interface element 614 can be selected to cause second user input section 608 to present user interface elements associated with settings associated with infant 604, and a selectable user interface element 616 can be selected to cause second user input section 608 to present user interface elements associated with parameters of a currently selected state.

In some embodiments, user interface 600 can correspond to an edit mode. In some embodiments, user interface 600 can receive input (e.g., user input) to design a range of patient case simulation scenarios through a series of controls that alter the holographic infant's movement, crying, breathing, heart sounds, skin coloration, and/or any other suitable parameters. In some embodiments, adjusting skin coloration can facilitate simulation of infants with various skin colorations and/or to simulate the affect of various medical conditions, such as cyanosis on an infant's skin coloration. In some embodiments, user interface 600 can also be used to adjust the display of a holographic vitals monitor that shows heart rate, oxygen saturation, and respiration.

In some embodiments, mechanisms described herein can utilize a data communication package that can allow a creator of an application to create parameters that present as a data object to be easily exposed to a user or to any other scripts within the application. The package can include pre-created data objects for many of the C#native types, as well as objects that are configured to handle triggers such as when a button is pressed.

In some embodiments, process 600 can provide access to a simulation framework that utilizes the data communication package. In some embodiments, the simulation framework can allow for the creation of scenarios based on the parameters created with data communication. For example, using an arbitrary set of data parameters, a user can create slideshows of whatever content is desired, with as many knobs as desired. In addition, the framework can support interpolation of parameters to create relatively realistic transitions between any two states (e.g., between a state in which heartrate is normal and a state in which heartrate is elevated). Addition, in some embodiments, the framework can be configured such that the application executing the simulation interprets states and displays each parameter are tailored to the specifications needed for a particular project.

FIG. 7 shows portions of portions of a user interface that can be used to generate a simulation scenario for generating a simulation of an infant in accordance with some embodiments of the disclosed subject matter. As shown in FIG. 7, a cloud user interface 702 can include selectable user interface elements that can be used to name a current simulation scenario, and to select a save location of the current simulation scenario. As described above, cloud user interface 702 can be presented in response to selection of selectable user interface element 612. Additionally, a parameter user interface 704 can be presented in response to selection of selectable user interface element 614.

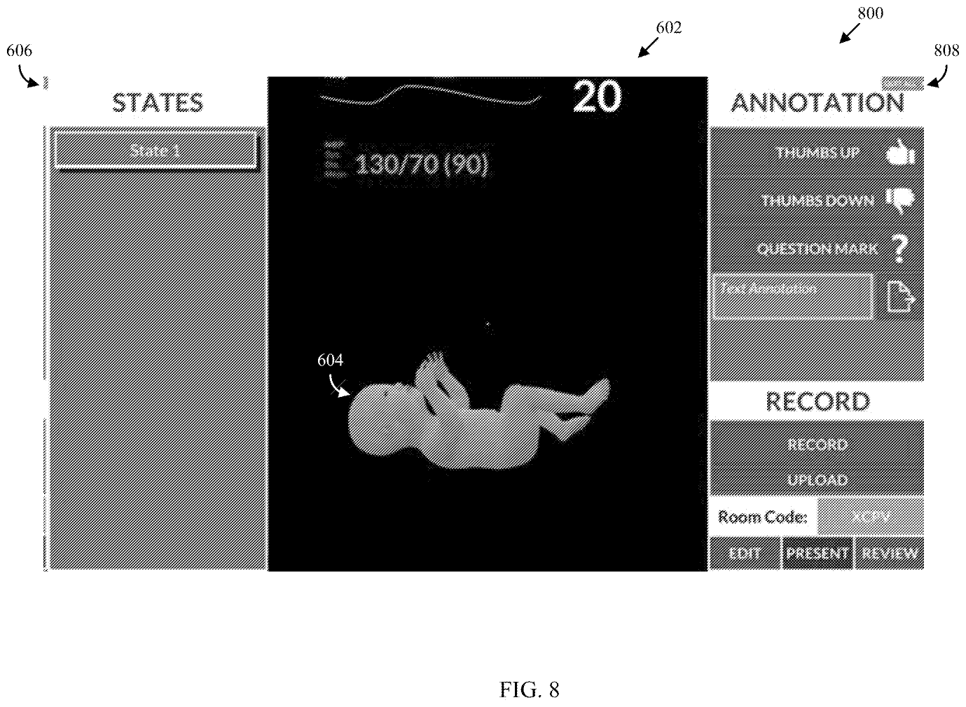

FIG. 8 shows an example 800 of a user interface that can be used to present a simulation of an infant in accordance with some embodiments of the disclosed subject matter.

As shown in FIG. 8, user interface 800 can be placed into a presentation mode in which second user interface section 608 can present a presentation user interface 808, which can be used to add annotations to a simulation that is being recorded, to initiate recording, to upload a recording, etc. Additionally, first user interface section 606 can be used to select a state to simulate and/or can present information about a currently selected state. In user interface 800, presentation portion 602 can present a current state of the infant being simulated.

In some embodiments, user interface 800 can correspond to a present mode. In some embodiments, a user (e.g., a simulation instructor) can add (e.g., via a keyboard) brief annotations and mark moments with a “thumbs up,” “thumbs down,” or question mark symbol on a timeline that can be used to drive reflection and conversation among learners during review of a simulation (e.g., in a review mode).

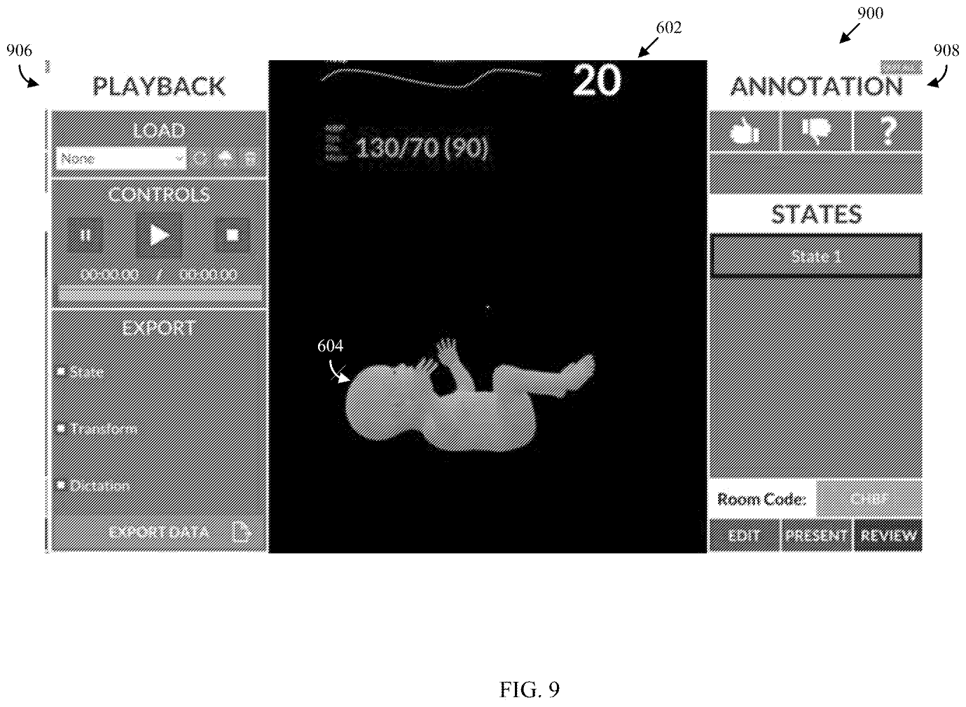

In some embodiments, mechanisms described herein can utilize an application metrics package. In some embodiments, the application metrics package can facilitate recording and/or playback of a simulation session for future review and/or analysis. For example, in some embodiments, any suitable data associated with the simulation can be recorded, such as: a position of a physical representation of an infant in a particular physical environment; a position of a simulated infant and/or a position of body parts of a simulated infant with respect to a portion of a physical environment; a position of a user in a physical environment; a position of a user's body part(s) (e.g., a user's hand(s)); a position of another physical object in a physical environment (e.g., a medical device, a prop medical device, etc.); a gaze direction of a user; image data recorded by a computing device (e.g., an HMD) participating in the simulation; etc. In such examples, the position can be recorded based on information collected and/or generated by an HMD and/or a position sensor(s). In some embodiments, data associated with a simulation can be recorded from multiple locations (e.g., if two or more HMDs are participating in a simulation and are located remotely, data can be recorded for both physical locations, and can be integrated based on a location of the physical representation of the infant and/or the simulation of the infant in each environment. In some embodiments, data associated with the simulation can be recorded at any suitable rate(s). For example, position information can be recorded at a particular rate and/or when position changes occur. As another example, video captured and/or generated by one or more HMDs can be recorded at a particular rate (e.g., a particular frame rate), which may be the same or different than a rate at which position information is recorded. Playback of a recorded session is described below in connection with FIG. 9. When a recording is loaded, the application can insert recorded values from simulation framework in order to share out the recorded movements to all connected devices.

In some embodiments, an HMD and/or mobile device participating in a simulation can present content presented within presentation portion 602 (e.g., with an orientation and size based on the location and/or position of the infant mannikin). In some embodiments, a user can interface with infant 604, and feedback can be provided via the HMD and/or mobile device executing the application used to present the simulation. For example, a user can touch the hologram and/or mannikin with a finger, and the application can play sounds (e.g., heartbeat sounds, breathing sounds) based on a location at which a user touched the hologram.

FIG. 9 shows an example 900 of a user interface that can be used to review a simulation of an infant in accordance with some embodiments of the disclosed subject matter. As shown in FIG. 9, user interface 900 can be placed into a presentation mode in which second user interface section 608 can present a review user interface 908, which can be used to review annotations and/or one or more states used during the simulation. Additionally, first user interface section 606 can present a playback control user interface 906 that can be used to control playback of a recorded simulation. In user interface 800, presentation portion 602 can present a state of the infant during a portion of the simulation that is being played back.

In some embodiments, user interface 900 can correspond to a review mode (which can also be referred to as a playback mode). In some embodiments, mechanisms described herein can cause a holographic review of a recorded simulation experience to be presented using an HMD or mobile display featuring a human scale representation of each participant in the form of an avatar head and hands (e.g., as described above in connection with FIG. 5). In some embodiments, words spoken during the experience can be displayed above the speaker's avatar head during the review. A similar playback view can be displayed on a screen of a device used to present user interface 900. This can facilitate observation and learning by users from their interactions during the simulation. Interactions such as head position, gaze, hand position and voice-to-text translations can be exported to a comma separate value (e.g., .csv file) or other suitable file.

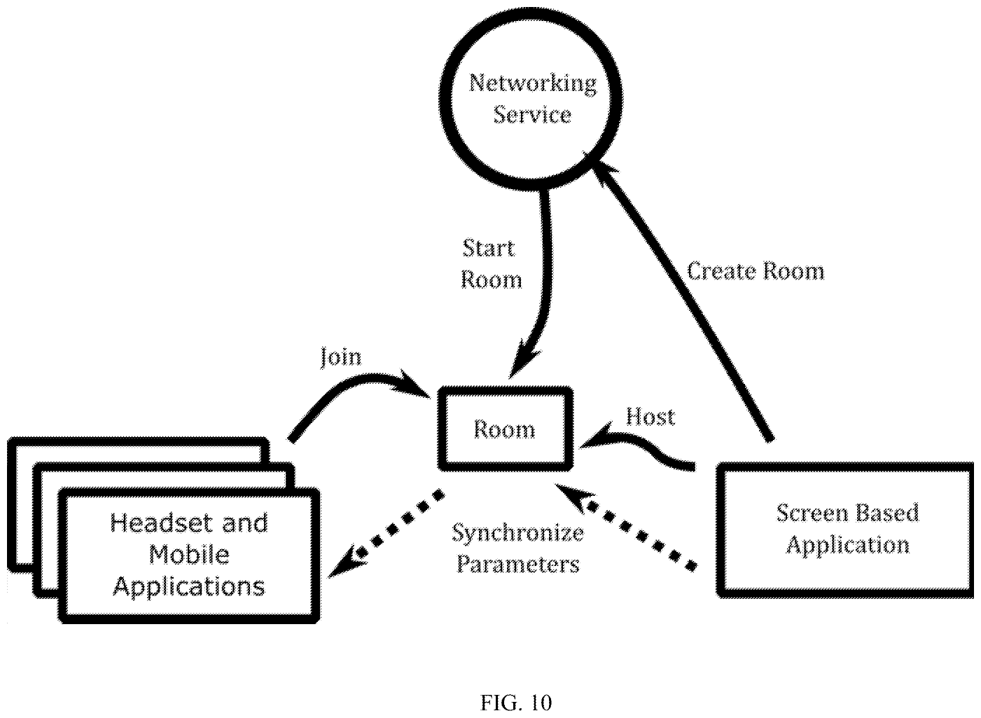

FIG. 10 shows an example of a flow for generating and presenting a simulation of an infant to multiple users in accordance with some embodiments of the disclosed subject matter. As shown in FIG. 10, a screen based application (e.g., executed by server 204, executed by a computing device interacting with server 204) can be used to create a room to be used to host a simulation, and a networking service (e.g., which may be executed by server 204) can start a room, which can be hosted by a user of the screen based application.

In some embodiments, HMDs and/or mobile devices executing corresponding application can join a simulation by joining the room that is hosted by the screen based application. In some embodiments, during a simulation, as states change (e.g., in response to input by a user of the screen based application, based on a sequence of states) parameters of the simulation can be synchronized with devices executing the simulation.

In some embodiments, a device executing the screen based application can act as a server to support networked or “shared” sessions among HMDs and/or mobile devices.

In some embodiments, HMDs and/or mobile devices can execute an application that facilitates users (e.g., instructors and/or learners) to view the holographic infant model overlaid onto the infant mannikin, as well as the holographic vitals monitor screen during a presentation mode.

In some embodiments, a screen based application (and/or a server application) can generate a 5 digit code that includes characters (e.g., letters and/or numbers) which can be used to join a specific session of a simulation. In some embodiments, a device (e.g., an HMD, a mobile device) executing an application can join a session by capturing an image of a code (e.g., a QR code encoded with the room code, the actual characters written out). Additionally or alternatively, in some embodiments, a device can be configured to list all created sessions in lieu of entering a code to join a specific session.

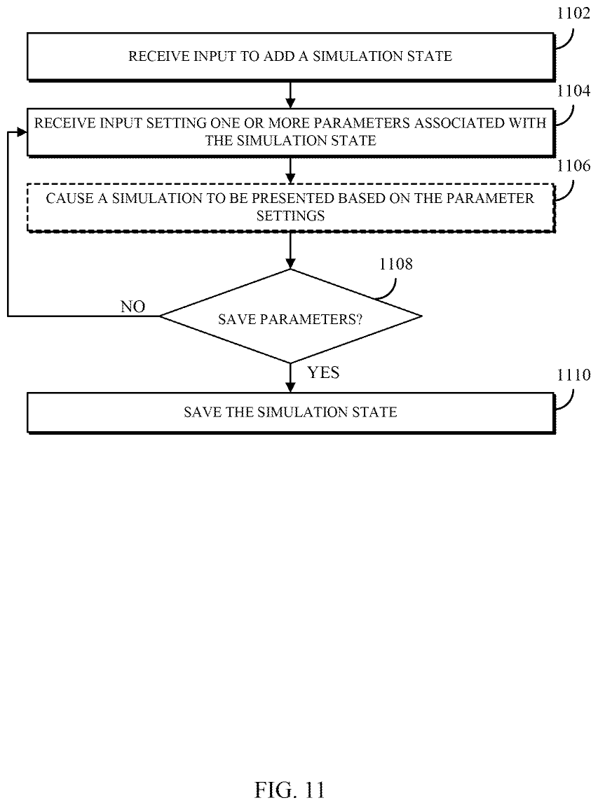

FIG. 11 shows an example 1100 of a process for generating a simulation scenario for a simulation with an infant in accordance with some embodiments of the disclosed subject matter.

At 1102, process 1100 can receive input to add a simulation state that can be used in a simulation scenario. In some embodiments, process 1100 can receive any suitable input to add the simulation state. For example, input can be provided via a user interface executed by a computing device (e.g., computing device 100), and the computing device can provide an indication that a simulation state is to be added (e.g., to a server executing process 1100). As another example, input can be provided via a user interface executed by a computing device (e.g., computing device 100) executing process 1100.

At 1104, process 1100 can receive input setting one or more parameters associated with the simulation state. For example, input can be provided via a user interface, such as user interface 704 described above in connection with FIG. 7.

At 1106, process 1100 can cause a simulation to be presented based on the parameter settings selected at 1104. For example, process 1100 can cause a display device (e.g., a conventional 2D display, an extended reality display device, such as HMD 100, or any other suitable display device) to present a simulation based on the state, which a user can utilize to confirm whether the selected parameters reflect an intended state anticipated by the user. In some embodiments, 1104 can be omitted.

At 1108, process 1100 can determine whether the parameters selected at 1104 are to be saved in connection with the state. For example, process 1100 can determine whether input and/or instructions have been received to save the parameters. As another example, process 1100 can determine whether a threshold amount of time has elapsed since a last input was received, and can determine that the parameters are to be saved in response to the threshold amount of time has passed. Alternatively, process 1100 can determine that the parameters are not to be saved in response to the threshold amount of time has passed.

If process 1100 determines that the parameters selected at 1104 are not to be saved (“NO” at 1108), process 1100 can return to 1104 and can continue to receive input to select parameters for the state.

Otherwise, if process 1100 determines that the parameters selected at 1104 are to be saved (“YES” at 1108), process 1100 can move to 1110.

At 1110, process 1100 can save the simulation state. For example, process 1100 can save the parameters selected at 1104 to a location (e.g., in memory 310). In some embodiments, the simulation state can be saved as any suitable type of file and/or in any suitable format, such as a.xml file.

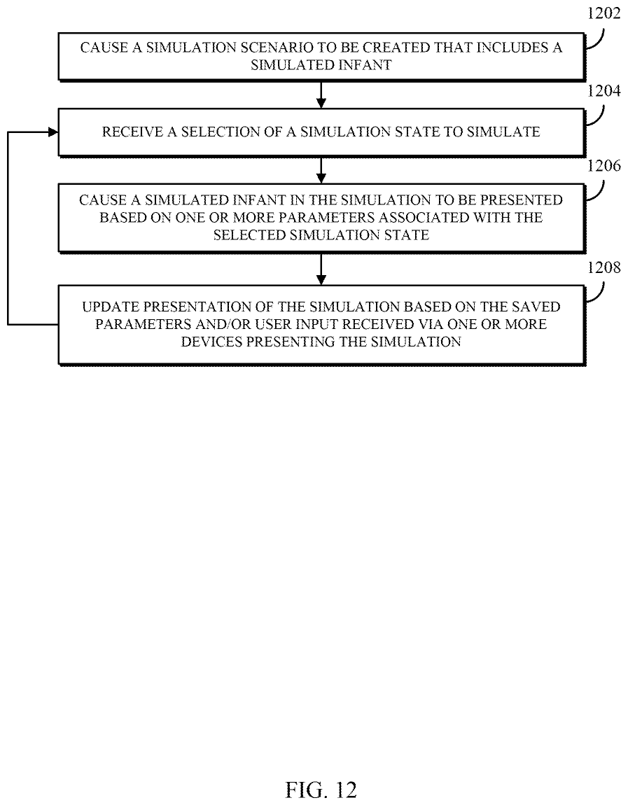

FIG. 12 shows an example 1200 of a process for presenting a simulation scenario for a simulation with an infant in accordance with some embodiments of the disclosed subject matter.

At 1202, process 1200 can cause a simulation scenario to be created that includes a simulated infant or other simulated subject (e.g., another type of subject that is incapable of communicating, such as a toddler, an unconscious person, etc.). For example, as described above in connection with FIG. 10, process 1200 can start a room to be used to host a simulation.

At 1204, process 1200 can receive a selection of a simulation state to simulate during the simulation scenario. In some embodiments, process 1100 can receive any suitable input to select a simulation state. For example, input can be provided via a user interface executed by a computing device (e.g., computing device 100), and the computing device can provide an indication of a selected simulation state (e.g., to a server executing process 1100). As another example, input can be provided via a user interface executed by a computing device (e.g., computing device 100) executing process 1100. In some embodiments, the selection of the simulation state can be an indication of a saved simulation state.

At 1206, process 1200 can cause a simulated infant (or other suitable subject) in the simulation to be presented via participating devices based on one or more parameters associated with the selected simulation state. For example, process 1200 can instruct each computing device participating in the simulation to begin presenting a simulated subject with particular parameters based on the state selected at 1204.

At 1208, process 1200 can update a presentation of the simulation based on the saved parameters and/or user input received via one or more computing devices presenting the simulation. For example, as described above in connection with FIG. 10, the parameters of the simulation can be synchronized with devices executing the simulation.

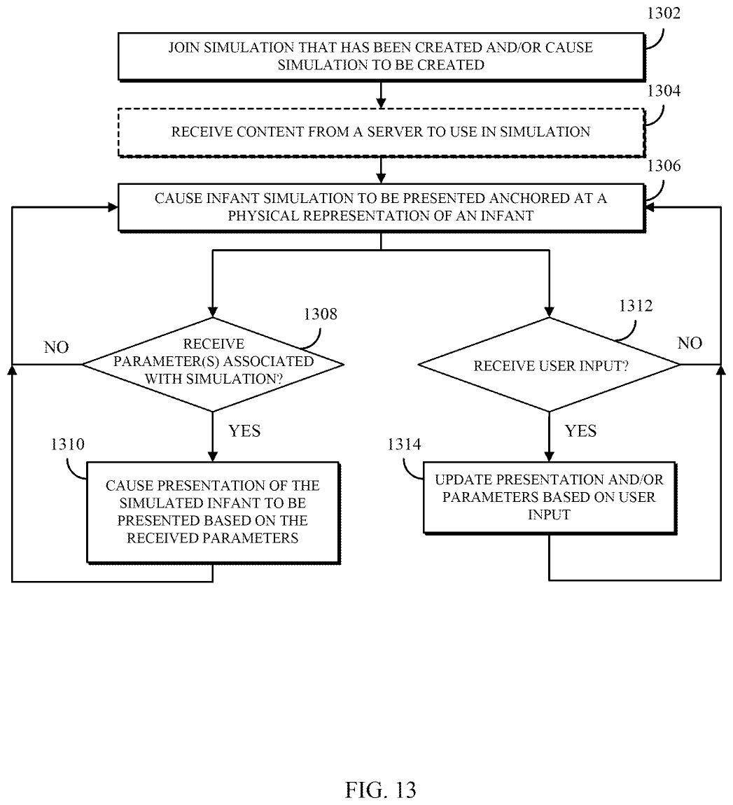

FIG. 13 shows an example 1300 of a process for participating in a simulation scenario for a simulation with an infant in accordance with some embodiments of the disclosed subject matter.

At 1302, process 1300 can join a simulation that has been created and/or cause a simulation to be created. For example, as described above in connection with FIG. 10, a computing device executing process 1300 can join a simulation using any suitable technique or combination of techniques. For example, process 1300 can join a room (e.g., a virtual room) that has been created to host the simulation (e.g., using a numerical code, using a QR code, etc.).

At 1304, process 1300 can receive content from a server to use in the simulation. For example, process 1300 can receive content and/or presentation information to be used in the simulation. In some embodiments, the content and/or presentation information can be transmitted using any suitable protocol(s), in any suitable format, and/or with any suitable compression applied (e.g., as described above).

At 1306, process 1300 can cause an infant (or other suitable subject) simulation to be presented anchored at a physical representation of an infant (or representation of another suitable subject). In some embodiments, process 1300 can use any suitable technique or combination of techniques to cause the simulation to be presented.

At 1308, process 1300 can determine whether parameters associated with the simulation have been received. If process 1300 determines that parameters associated with the simulation have not been received (“NO” at 1308), process 1300 can return to 1306.

If process 1300 determines that parameters associated with the simulation have been received (“YES” at 1308), process 1300 can move to 1310. At 1310, process 1300 can cause presentation of the simulated infant to be presented based on the received parameters. For example, process 1300 can update the simulation based on the updated parameters, such as an updated heart rate, updated respiration, updated oxygen, updated blood pressure, etc.

At 1312, process 1300 can determine whether input has been received. If process 1300 determines that user input has been received (“NO” at 1312), process 1300 can return to 1306. In some embodiments, process 1300 can determine whether input has been received using any suitable technique or combination of techniques. For example, input can be provided via a user input device (e.g., user input device 230). As another example, input can be provided via movement of a user's body part (e.g., a hand, a part of a hand, etc.). In such an example, a device or devices (e.g., HMD 100, position sensor 240, etc.) can detect a movement corresponding to an input, and process 1300 can determine that input has been received based on the detection.

If process 1300 determines that input has been received (“YES” at 1312), process 1300 can move to 1314. At 1314, process 1300 can cause presentation of the simulated infant to be updated based on the received input. For example, process 1300 can update the simulation to present a virtual tool (e.g., a virtual stethoscope) based on user input (e.g., a detection of a user's finger in proximity to the physical representation of the subject). As another example, process 1300 can update the simulation to add an audio and/or visual representation of a parameter (heart rate, updated respiration, updated oxygen, updated blood pressure, etc.) based on the user input indicating that the audio and/or visual representation of the parameter.

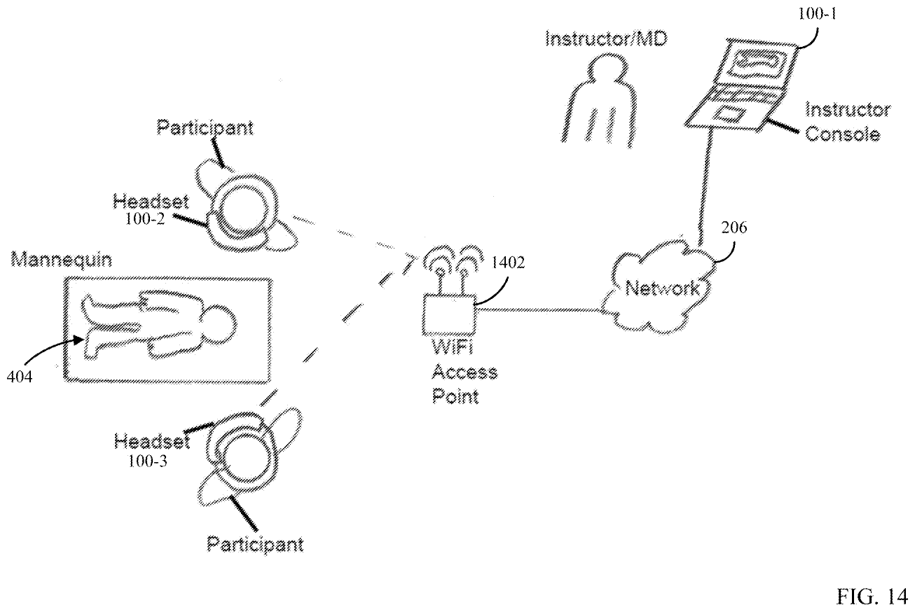

FIG. 14 shows an example 1400 of a simulation environment and a system including head mounted displays and a computing device and a server in accordance with some embodiments of the disclosed subject matter.

As shown in FIG. 14, one or more participants wearing head mounted displays 100-2 and 100-3 and a computing device 100-1. In some embodiments, computing device 100-1 can be used (e.g., by an instructor/doctor) to begin a simulation, to view image(s) from the perspective of an HMD, to initiate a scenario, to change states, etc. In some embodiments, computing device 100-1 can be used to select a simulation state, to transmit parameters associated with the simulation state(s), etc.

In some embodiments, a head mounted display(s) (e.g., HMD 100-2 and/or 100-3) can generate an image of the simulation that is being presented by the HMD, and can transmit the image(s) to computing device 100-1 via computing network 206, which can include a wireless access point 1402 to which the HMD is connected to computing network 206.

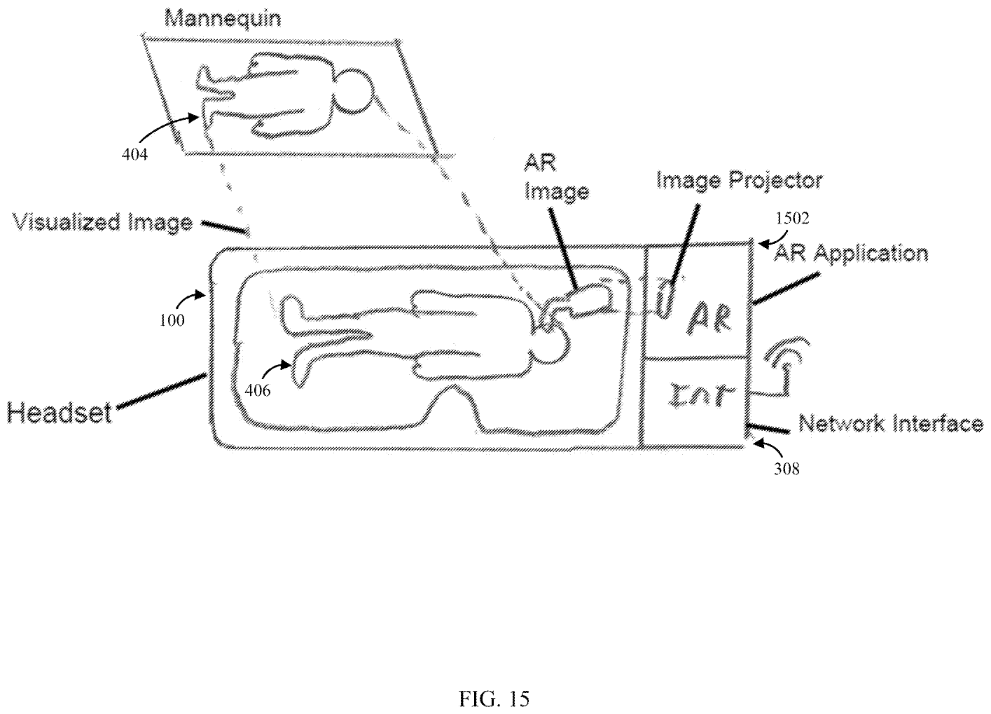

FIG. 15 shows an example of a simulation presented by a hear mounted display in a system including head mounted displays and a computing device and a server in accordance with some embodiments of the disclosed subject matter.

As shown in FIG. 15, an HMD (e.g., HMD 100) can use an extended reality application 1502 to present a hologram 406 anchored at a position of a physical representation of a subject 404. As shown in FIG. 15, the simulation can include the simulated subject, and a simulated medical device (e.g., a respirator). In some embodiments, XR application 1502 can include and/or execute instructions for rendering any suitable scenario, such as an infant resuscitation scenario. In such a scenario, an infant resuscitation scenario can include (e.g., via rendered overlay images a display of the HMD) a distressed infant and a treatment action. In some embodiments, HMD 100 can be configured to execute multiple simulation scenarios, which can be executed in part, based on instructions provided by a computing device (e.g., computing device 100-1).

### Further Examples Having a Variety of Features

Implementation examples are described in the following numbered clauses:

1. A method for simulating interactions with an infant, comprising: receiving input to add a state; receiving input setting one or more parameters associated with the state; causing content to be presented based on the parameters via a display; saving the parameters; receiving a selection of the state; and in response to receiving the selection of the state, causing a simulated infant in the simulation to be presented based on the one or more parameters.

2. The method of clause 1, further comprising: receiving, during the simulation, an indication that user input has been received; selecting a second state based on the user input; and causing the simulated infant to be updated based on the second state.

3. The method of clause 2, further comprising: transmitting parameters associated with the second state to the remote computing device.

4. The method of any one of clauses 1 to 3, further comprising: receiving, during the simulation from a remote computing device, an image of the simulated infant being presented by the remote computing device; and presenting the image of the simulated infant via the display.

5. The method of clause 4, further comprising receiving, via a user interface, a selection of a user interface element; and storing an annotation to the simulation to be saved in connection with the simulation.

6. A method for simulating interactions with an infant, comprising: joining a simulation of an infant; receiving content from a server; causing the content to be presented anchored at a location corresponding to a physical representation of an infant; receiving, from a remote device, one or more parameters associated with the simulated infant; and causing presentation of the content to be updated based on the one or more parameters.

7. The method of clause 6, further comprising: receiving, from the remote device, one or more updated parameters associated with the simulated infant; and causing presentation of the content to be updated based on the one or more updated parameters.

8. The method of clause 7, further comprising: determining that user input has been received; transmitting, to the remote device, an indication that the user input has been received; and receiving, subsequent to transmitting the indication, the one or more updated parameters associated with the simulated infant.

9. The method of any one of clauses 6 to 8, further comprising: detecting a position of an object in proximity to the physical representation of the infant; and in response to detecting the position of the object in proximity to the physical representation of the infant, causing a virtual representation of a medical device to be presented in connection with the content.

10. The method of clause 9, wherein the object is a finger of the user, and wherein the medical device is a stethoscope.

11. The method of any one of clauses 9 or 10, further comprising: transmitting, to the remote computing device, a position of the object in proximity to the physical representation of the infant.

12. The method of any one of clauses 6 to 11, further comprising: detecting a position of an object in proximity to the physical representation of the infant; and causing presentation of the content to be updated based on the position of the object.

13. The method of clause 12, further comprising: causing, in response to detecting the position of the object, a heart rate of the simulated infant to be presented.

14. The method of clause 13, wherein the heart rate is presented using a user interface element.

15. The method of any one of clauses 13 or 14, wherein the heart rate is presented using an audio signal.

16. A system for simulating interactions with an infant, comprising: at least one processor that is configured to: perform a method of any of clauses 1 to 15.

17. A non-transitory computer-readable medium storing computer-executable code, comprising code for causing a computer to cause a processor to: perform a method of any of clauses 1 to 15.

In some embodiments, a scenario can cause appropriate images to be rendered in response to participant actions (e.g., user inputs). In some embodiments, a user of a computing device executing an instruction program can direct response/feedback as a scenario progresses. One or more infant resuscitation scenarios can include one or more medical devices (which can be represented by a physical prop and/or can be rendered virtually), such that the medical device, when manipulated based on the resuscitation scenario, results in a rendered difference in the distressed infant. For example, movements of the simulation of the infant decrease and/or cease if under simulated respiratory distress, and can change color from pale to pink/more flush and commence movement in response to an infant respiration device. In such an example, a user can position a medical device (e.g., a simulated medical device) in a position with respect to the simulated infant and/or physical representation of the infant, and HMD 100 can provide an indication to computing device 100-1 indicating the position of the medical device, and computing device 100-1 can cause a state of the simulation to change in response to the position of the medical device.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any other suitable media that is fleeting and devoid of any semblance of permanence during transmission, and/or any suitable intangible media.

It will be appreciated by those skilled in the art that while the disclosed subject matter has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is hereby incorporated by reference, as if each such patent or publication were individually incorporated by reference herein.

Various features and advantages of the invention are set forth in the following claims.

1. A system for simulating interactions with an infant, comprising:
a display; and
at least one processor, wherein the at least one processor is programmed to:
receive input to add a state;
receive input setting one or more parameters associated with the state;
cause content to be presented based on the parameters via the display;
save the parameters;
receive a selection of the state; and
in response to receiving the selection of the state, cause a simulated infant in the simulation to be presented based on the one or more parameters.

2. The system of claim 1, wherein the at least one processor is further programmed to:
receive, during the simulation, an indication that user input has been received;
select a second state based on the user input; and
cause the simulated infant to be updated based on the second state.

3. The system of claim 2, wherein the at least one processor is further programmed to:
transmit parameters associated with the second state to the remote computing device.

4. The system of claim 1, wherein the at least one processor is further programmed to:
receive, during the simulation from a remote computing device, an image of the simulated infant being presented by the remote computing device; and
present the image of the simulated infant via the display.

5. The system of claim 4, wherein the at least one processor is further programmed to:
receive, via a user interface, a selection of a user interface element; and
store an annotation to the simulation to be saved in connection with the simulation.

6. A system for simulating interactions with an infant, comprising:
a head mounted display comprising:
a display; and
at least one processor, wherein the at least one processor is programmed to:
join a simulation of an infant;
receive content from a server;
cause the content to be presented anchored at a location corresponding to a physical representation of an infant;
receive, from a remote device, one or more parameters associated with the simulated infant; and
cause presentation of the content to be updated based on the one or more parameters.

7. The system of claim 6, wherein the at least one processor is further programmed to:
receive, from the remote device, one or more updated parameters associated with the simulated infant; and
cause presentation of the content to be updated based on the one or more updated parameters.

8. The system of claim 7, wherein the at least one processor is further programmed to:
determine that user input has been received;
transmit, to the remote device, an indication that the user input has been received; and
receive, subsequent to transmitting the indication, the one or more updated parameters associated with the simulated infant.

9. The system of claim 6, wherein the at least one processor is further programmed to:
detect a position of an object in proximity to the physical representation of the infant; and
in response to detecting the position of the object in proximity to the physical representation of the infant, cause a virtual representation of a medical device to be presented in connection with the content.

10. The system of claim 9, wherein the object is a finger of the user, and wherein the medical device is a stethoscope.

11. The system of claim 9, wherein the at least one processor is further programmed to:
transmit, to the remote computing device, a position of the object in proximity to the physical representation of the infant.

12. The system of claim 6, wherein the at least one processor is further programmed to:
detect a position of an object in proximity to the physical representation of the infant; and
cause presentation of the content to be updated based on the position of the object.

13. The system of claim 12, wherein the at least one processor is further programmed to:
cause, in response to detecting the position of the object, a heart rate of the simulated infant to be presented.

14. The system of claim 13, wherein the heart rate is presented using a user interface element.

15. The system of claim 13, wherein the heart rate is presented using an audio signal.
